(19) United States
(12) Patent Application Publication
(10) Pub. No.: US 2015/0352860 A1
(43) Pub. Date: Dec. 10, 2015

(54) CHARACTER ACTUATOR DEVICE FOR FORMING WORDS

(71) Applicant: SHERRIE L. BENSON, Redding, CA (US)

(72) Inventor: SHERRIE L. BENSON, Redding, CA (US)

(21) Appl. No.: 14/297,501

(22) Filed: Jun. 5, 2014

(51) Int. Cl. B41J 3/26

(52) U.S. Cl. CPC B41J 3/26

(57) ABSTRACT

A character actuating device for forming words utilizing a plurality of actuators that form the beginnings, endings, and vowel structures in words found in multiple languages. Certain actuators may also be employed to alter the words formed by the first, second, and third actuators, as wells as to shorten the number of strokes needed to form the words used by first, second, and third actuators.

### CROSS-REFERENCES TO RELATED APPLICATIONS

The present application claims the benefit of U.S. provisional patent application 61/832,572, filed 7 Jun. 2013 and U.S. provisional patent application 61/861,584, filed 2 Aug. 2013.

### BACKGROUND OF THE INVENTION

The present invention relates to a novel and useful character actuator device for forming polysyllabic words.

Transcription of words may be accomplished using a typewriter, a stenographic keyboard, the latter using the format of a consonant-vowel-consonant structure. The common typewriter operates at a slower pace than a stenographic keyboard. However, the stenographic keyboard provides words that are often abbreviated and require the use of a supplemental dictionary to provide the proper spelling of the words. In addition, multiple strokes are also employed with a stenographic keyboard to create a single word.

Reference is made to U.S. Pat. Nos. 6,948,868, 7,253,751, and 8,496,391, which are incorporated by reference as a whole to the present application. These patents show a novel method of writing language components using a keyboard which is operated using the palm portion of the hand, simultaneously with the fingers of a hand, to create words using a two handed single stroke on the keyboard disclosed in these patents. Although serving as a notable advance in the field of transcribing words, there is a need to provide tenting abilities as well as additional keyboard functions to further aid in the creating words in a rapid and efficient manner.

### SUMMARY OF THE INVENTION

In accordance with the present invention a novel and useful character actuating devices for forming words are herein provided.

A device of the present invention utilizes a character actuator which employs the first, second, and third plurality of character actuators fully described U.S. Pat. No. 8,496,391. In addition, a fourth category of character actuators is employed to alter any polysyllabic word formed by the first, second, and third character actuators. Needless to say, the first, second, third, and fourth actuators are adapted for simultaneous activation to produce a signal representing a word. Specifically, the fourth category of character actuators is used to modify, add, subtract, or substitute portions of the words being formed by the first, second, and third character actuators of the actuator device of the present invention.

Namely, the fourth category of actuators may be used to indicate capitalization of a word or words formed by the first, second, and third character actuators. In addition, accents may be inserted within said words, as well as an addition or substitution of a vowel or consonant in the word being formed. It should be realized that activation of any of the fourth category of actuators is accomplished in a single stroke using one or both hands of the user. Moreover, the words created by the first, second, and third character actuators may be more easily formed by the addition of certain ending keys, namely keys adding the “y” or “ry” endings. Other actuators of the fourth actuator category of actuators may be employed to switch such device between the Romanic alphabet non-Romanic alphabet, thus forming words in various languages. Again, yet another one of the fourth category of actuators may be used to change vowels designated by the first, second, and third plurality of actuators to yet another vowel or to add a vowel to such words formed therewith.

Further, a character actuator device is found in the present application which may be used by a single hand of the user and is especially useful for texting. Such single hand texting device employs at least a first plurality of finger activated character actuators in combination with a character actuator activated by the palm region of the hand. Such palm activated character actuator is, of course, activated simultaneously with one or more of the first plurality of finger activated character actuators. The eventual output would be a word, a portion of a word, or a phrase.

It may be apparent that novel and useful character actuator devices have been hereinabove described.

It is therefore an object of the present invention to provide a character actuator device to form a word which utilizes multiple groups of actuators to form the beginning and ending of a word and to modify such word to produce a properly spelled word.

Another object of the present invention is to provide a character actuator device that may be used to create words in various languages.

Yet another object of the present invention is to provide a character actuator device which includes actuators that alter a word formed by other actuators in order to provide words having proper grammatical appearance.

Another object of the present invention is to provide a character actuator device which is capable of forming words faster than using a conventional typewriter.

Yet another object of the present invention is to provide a character actuator device which may be employed by using the two hands of the user and is capable of forming properly spelled word in a single stroke.

Another object of the present invention is to provide a character actuator device which is used by a single hand of the user and is capable of forming words or portion of words or phrases in a single or multiple stroke format.

Another object of the present invention is to provide a character actuator device which is readily adaptable to electronic presentation, especially useful in a mobile communication device.

A further object of the present invention is to provide a key structure and method for generating a message which will take the form of a physical or virtual system.

Yet another object of the present invention is to provide a key structure and method for generating a method of creating words which is easily learned by users of the same.

Another object of the present invention is to provide a character actuator device that generates words and employs fingers and palm region of the hand of the user.

Yet another object of the present invention is to provide a message generating device and method that does not require the user to continually view the keyboard when generating a word or words.

The invention possesses other objects and advantages especially as concerns particular characteristics and features thereof which will become apparent as the specification continue.

### BRIEF DESCRIPTION OF THE SEVERAL VIEWS OF THE DRAWING

FIG. 1 is a top plan view of a character actuator device which employs both hands of the user.

FIG. 2 is a top plan view of a character actuator device which employs one hand of the user.

FIG. 3 is a schematic diagram generally outlining the generation and sending of a message to a recipient of the same.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

Various aspects of the character actuator device 10 revealed in the following detailed description of the preferred embodiments. Such embodiments of the device are designated by the reference character 10 followed by an upper case letter to denote variations.

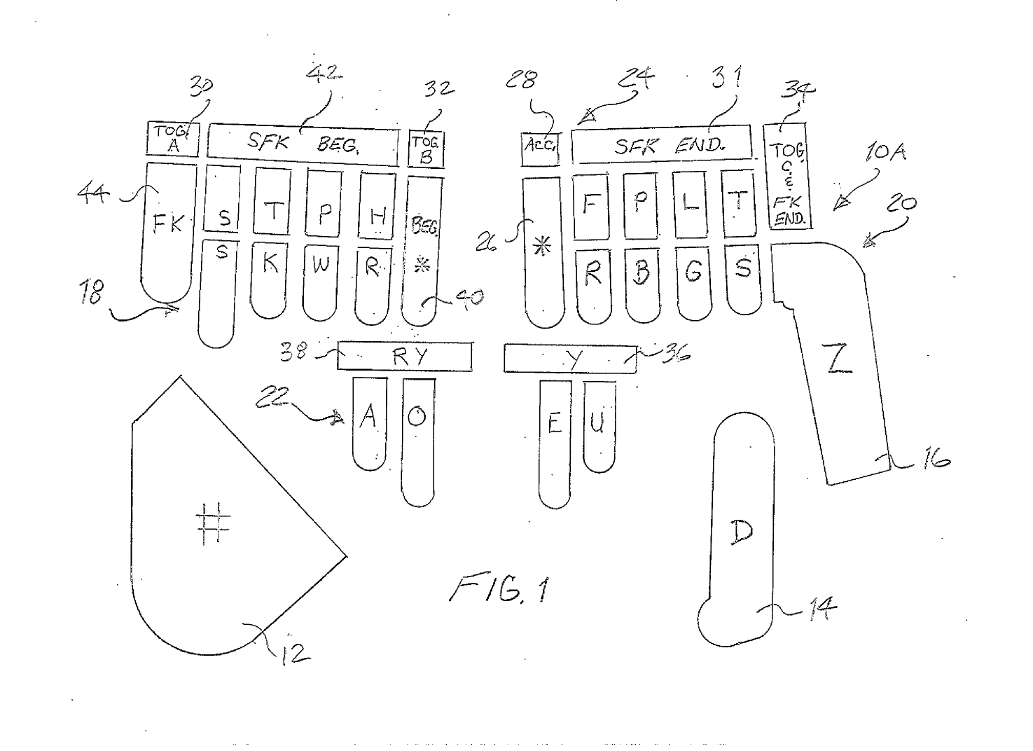

With reference to FIG. 1, a character actuator device 10A is depicted. Device 10A is similar in certain aspects to the character actuator unit found in U.S. Pat. No. 8,496,391 and to the keyboard found in U.S. Pat. No. 6,948,868 which are both incorporated by reference as a whole to the present application. Although not depicted in FIG. 1, each of the keys shown therein by conventional linkages to produce a signal capable of creating word, portion of a word, and the like. Also, it should be pointed out that #key 12, “D” key 14, and “Z” key 16 are intended to be depressed or activated by the palm region of the hand, specifically key or pad 12 by the palm of the left hand and keys or pads 14 and 16 by the palm of the right hand of the user. It should also be realized that keys 12, 14, and 16 are pressed or activated simultaneously in a certain pattern with the remaining keys which will be discussed hereinafter. Keys letter STPHSKWR are categorized as a first plurality of character actuators 18. First plurality of actuators 18 represent the beginnings of words formed by device 10. A second plurality of actuators 20, are identified by the letters FPLTRBGSD and Z. In addition, a third plurality of actuators 22 represent the vowel keys AOEU. The second and third plurality of actuators 20 and 22 represents the endings of words. The assignment of particular character actuators or keys in first plurality of actuators 18 generates the beginning of the words and are identified in the following table:

TABLE I
FIRST CATEGORY OF ACTUATRS 18

| LETTERS | KEYS(s) |
|---|---|
| GENERATED | CATEGORY 18 |
| A- | STP |
| B | PW |
| C | K |
| CH | KH |
| D | TK |
| E | SPHR |
| F | TP |
| G | TKPW |
| H | H |
| I | I |
| J | SKWR |
| K | STK |
| L | HR |
| LL | TKHR |
| M | PH |
| N | TPH |
| P | P |
| Q | KW |
| R | R |
| S | S |
| T | T |
| U | SPH |
| V | SR |
| W | W |
| X | KP |
| Y | SKPH |
| Z | SKP |

The following Table II represents, in part, the assignment of character actuators or keys of second category of character actuator 20 to generate endings of words:

TABLE II
SECOND CATEGORY OF ACTUATORS 20

| LETTERS | KEY(S) USED |
|---|---|
| GENERATED | IN CATEGORY 20 |
| B | B |
| C | BG |
| CH | FBS |
| D | D |
| F | FP |
| G | G |
| H | FRB |
| J | FPGS |
| K | BS |
| L | L |
| M | PL |
| N | PB |
| Ñ | RPGTS |
| P | P |
| Q | PGS |
| R | R |
| S | S |
| T | T |
| TH | PT |
| V | F |
| W | FB |
| X | BLGS |
| Y | FPG |
| YY | FRPGTS |
| Z | *S OR *Z |
| B, βt | BLT |

The following Table III shows, in general, the eight vowels or vowel combinations which affect the formation of word endings: i.e. (1) short vowels, (2) long vowels, (3) “AO” vowels, (4) AEU/OEU vowels, (5) Latin vowels, (6) AU/OU vowels, (7) U vowels, and (8) no vowels: Using actuators 22 of FIG. 1.

TABLE III

SHORT VOWELS KEYS USED
A
E
EU
O
U
LONG VOWELS KEYS USED
AE
AOE
AOEU
OE
AOU
AO VOWELS KEYS USED
AO
AEU/OEU VOWELS KEYS USED
AEU
OEU

LATIN VOWELS (using in this example the simple consonant
ending “T” and showing sample word created)

| ACTUAL PRINTOUT | KEY USED | SAMPLE WORD |
|---|---|---|
| ATA | A#ET | data |
| ATO | A#UT | gato |
| ATE | A#T | date |
| ETA | O#ET | beta |
| ETO | O#UT | veto |
| ETE | #ET | pet |
| ITA | AO#T | vita |
| ITO | AO#EUT | Ito |
| ITE | #EUT | bite |
| OTA | A#EUT | nota |
| OTO | O#EUT | Moto |
| OTE | O#T | vote |
| UTA | AO#E | Uta |
| UTO | AO#U | Muto |
| UTE | #UT | mute |

AU/OU VOWELS KEYS USED
AU
OU
U VOWELS KEYS USED
U
NO VOWELS KEYS USED
None

For example, the following words may be formed using certain actuators of device 10A

TABLE IV

| KEYS | WORD |
|---|---|
| PWAET | BAT |
| KOET | COT |
| PWAOUTZ | BUTS |
| SAOEUTZ | SITS |

Most importantly, device 10A includes a fourth category of actuators 24 identified with a particular character on FIG. 1, each character being associated with alterations of the polysyllabic word being formed by first, second, and third character actuators 18, 20, and 22. It should also be noted that fourth category of actuators 24, which will be detailed hereinafter, are activated simultaneously with first, second, and third plurality of actuators 18, 20, and 22.

Fourth category of actuators includes actuator 26 identified by an “*”. Actuator key 26 when activated or pressed, capitalizes a word formed by actuators 18, 20, and 22 or, when used together with another fourth category key, changes the word formed by actuators 18, 20, and 22 to all capital letters.

Fourth category of actuators 24 also includes actuator 28 which is an accent key (abbrev on FIG. 1 as ACC). When activated, actuator 28 replaces a word formed by actuators 18, 20, and 22 with the accented form of the word. Of course, software associated with device 10A would achieve this result. For example “si” is replaced with “sí”. It should also be realized that actuators 26 and 28, being in close proximity to one another, may be easily activated or pressed at the same time. Thus, actuators 26 and 28 may both capitalize and accent a word in one stroke.

Fourth category of actuators 24 also includes actuator 31 identified as SFK END., on FIG. 1. Actuator 30 adds a vowel to a word formed by actuators 18, 20, and 22.

Fourth category of actuators 24 also includes actuators 30, 32 and 34, identified as “TOG A”, “TOG. B”, and “TOG. C & FK END”, on FIG. 1. Generally actuators 30, 32, and 34 are used, with appropriate software, to spell check, to change certain accents to certain languages, or to shift device 10 and actuators 18, 20, and 22 for use between the characters in the Roman and a non-Roman alphabet. Actuator 34 may also be employed to provide an ending function when used together with other keys.

Actuator 36, identified as “Y”, serves as a substitute for the use multiple keys of actuators 18, 20, and 22 to form consonant-Y and consonants-y endings found in the methods shown in U.S. Pat. No. 8,496,391. For example, the ending of a word “my” using the second plurality of actuators would be created in the prior art with the following keys:
RPBLG
   Using the actuator 36, the ending “MY” would be written:
PL+“y” key.

Fourth category of actuators also includes the “RY” key 38. Again, actuator 38 replaces the employment of multiple keys used from second category of actuators 20. For example, for a word ending in “STRY”, the following keys are used in the prior art:
FBTS.
   activating actuator 38, the “RY” key, the same ending would be written:
TS+“RY” key.
   Fourth category of actuators also includes the beginning * key 40, abbreviated as “BEG.*”. When activated, actuator 40 adds another consonant to words using consonant vowel (CONVOS) and consonant-(CONCOS) combinations. Using first category of actuators 18, the beginning of a word having the letters “cl” would use the following keys:
KHR.

Simultaneously, adding the actuator 40 to such keys would change the “cl” to “chr”. For example, the word “chrome” would be formed by pressing the following actuators:
KHR+BEG*+O #PL.

The word “clone” is formed by actuators:
KHRO#PB

Also, actuator 40 may be used to further alter a word combination such as the word beginning “chl” to “chlr”. For example, the word “chloramine” would be written by certain actuators:
KHR+BEG*+BEG*AEPBLS.

The fourth category of actuators also encompasses the beginning SFK key 42 (SFK BEG). For example, the following changes would occur with a CONVO, using actuator 42 where a vowel is changed from:
U to O.
E to A
I to Y.
   For instance, the CONVO “clu” would be changed to “clo” using the SFK BEG. actuator 42. In addition, if a CONCO such as “cl” is written, in combination with actuator 40, would produce the word beginning “chr”. Further activation of the SFK BEG actuator 42 would add a vowel to such CONCO i.e. “chyr”. In addition, actuator 42, activated alone, may be programmed to create special briefs used in word beginnings. For example, the word “INDUSTRY” is formed by pressing the following actuators:
SFK BEG+TKPH

Fourth category of actuators 24 also utilizes the function key 44 (FK). Actuator 44 when activated adds a vowel within a CONCO or a vowel after a CONVO. In addition, actuator 44 may be used in combination with other keys such as actuator 42, SFK BEG. when this occurs with a CONCO, actuator 42 adds a second vowel to the first vowel added by the use of actuator 44, the FK key. For example, the conco “cl” would have a “u” added by activation of actuator 44 producing the combination “cul”. The further use of the SFK BEG, key 42 would add another vowel producing “cuil”. In addition, activating the SFK BEG key 42, the FK key 44, and the BEG.*key 40 with a CONCO would add two vowels to the CONCO or add a vowel between the last two consonant of a CONCO.

Using actuators structure 10A, the user may compose any word after learning only the beginning and ending alphabet and the short vowels combined with the use of the actuator 52, “*BEG”. Using the word “macaroni” as a sample word, such word may be created as follows using one or more strokes:
a. Four strokes: output: ma ca ro ni
   Keys activated: PHA* KA* RO* TPHEU
   Word created: “macaroni” (using only short vowels and only the beginning alphabet).
b. Three strokes: output: maca ro ni (after learning Latin vowels) Keys activated: PH#AEBG RO* TPHEU
   Word created: “macaroni” (using the Latin vowel A-consonant-A)
c. Two strokes: output: maca roni (after learning long vowels, “y” and “ry” key and
   Keys Activated PH#A*EBG RO*EPB (Y KEY)
d. One stroke: output: “macaroni” (after learning beginning CONCOS, modifiers keys and further skills).
   Keys activated: KPH(FK)#A*URPBS
   Word created: “macaroni” (using the CONCO mc with the function key to insert the “a”, and the Latin Vowel A-Consonants-O, together with the consonants-Y keyoutline for RNY, causing the o to come before the ny, and the * which changes the “y” to i.)

A user of device 10A may write “macaroni” in one stroke at one time and in four strokes, the next time. The word “macaroni” will appear no matter how many strokes are used or how long it takes to write those strokes.

Even if the user never gets past the first step of learning the alphabet and the short vowels, through this method on device 10A, the number of strokes has at least been cut in half from the use of a QWERTY typewriter in creating the word “macaroni”

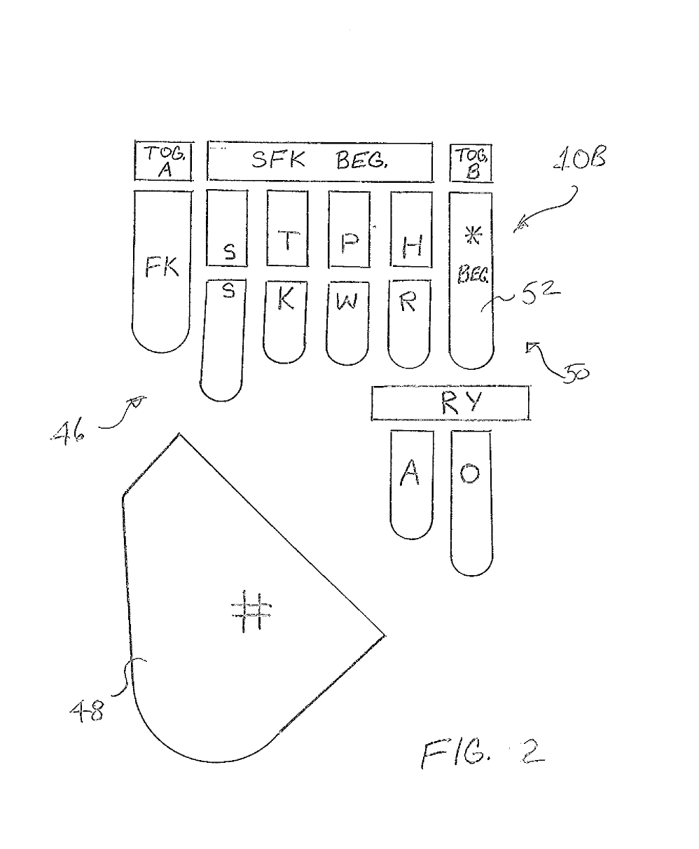

Turning now to FIG. 2, it may be observed that another embodiment 10B of the device of the present application is shown. FIG. 2 depicts a top plan view of an actuator or key structure 10B having a plurality of actuators 46. In general, pad actuator 48 is intended to be operated by the palm region of a single hand of the user. In the embodiment shown in FIG. 2, actuator structure 10B is intended to be used by the left hand of the user. However, should the user prefer the use of a right hand, the mirror image of the structure depicted in FIG. 2, would be employed. Other than actuator 48, the remaining plurality of actuators 50, comprise finger operated actuators. Each key or actuator on FIG. 2 is designated with a symbol representing a letter or sign. For example, pad actuator 48 bears a “#”. The remaining keys are used to create words using a single hand with one or more strokes. Although actuator structure 10B is shown as a physical keypad, structure 10B may be reproduced in a virtual keypad projected on a surface viewed by the user in any manner, including a projection of the same directly to the user's brain or by the use in the mind's eye. Also, any of the plurality of actuators 46 may be activated, mechanically, electronically, or otherwise, singularly or together, in combinations, which will be discussed hereinafter.

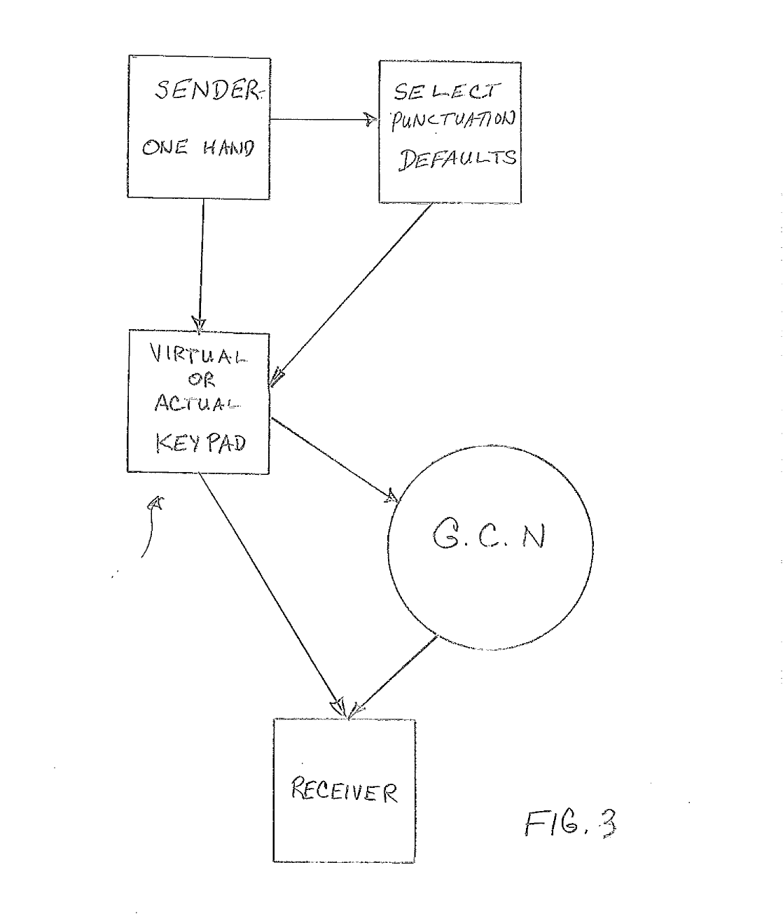

FIG. 3 represents the general method of the present invention utilizing a keyboard or actuator structure of FIG. 2. It should be realized that a message or text may be created in any language based on the Roman alphabet and is generated by the sender through the use of key structure 10B by manipulation via a single hand of a user or sender. Again, plurality of actuators 46 may be depressed individually or simultaneously. In addition, signals generated by any of the plurality of actuators 46 of actuator structure 10B may be sent to a personal computing device, the global computer network, or any other designated receiver.

Utilizing the actuator structures 10A or 10B of FIG. 1 or 2, there is no “one way” to create a word. When used with a spelling table, words are put together and may be utilized in multiple languages. The following Table V represents the creation of alphabetic letters, for structure 10B.

TABLE V
ALPHABET

| KEYS USED | ALPHABET LETTER |
|---|---|
| STP | A |
| PW | B |
| K | C |
| TK | D |
| SPHR | E |
| TP | F |
| TKPW | G |
| H | H |
| KWR | I |
| SKWR | J |
| STK | K |
| HR | L |
| PH | M |
| TPH | N |
| STHR | O |
| P | P |
| KW | Q |
| R | R |
| S | S |
| T | T |
| SPH | U |
| SR | V |
| W | W |
| KP | X |
| SKPH | Y |
| SKP | Z |
| STKR | Ñ |
| TPW | β |

The following table shows key combinations used on device 10B for fashioning punctuation marks.

TABLE VI
PUNCTUATIONS

| KEYS USED | PUNCTUATION |
|---|---|
| A + Tog. B | insert space |
| A + Tog. B | insert 2 spaces |
| SKWR A | insert period and 1 space |
| SKWR 0 | insert period and 2 spaces |
| SKWR *BEG. | insert decimal point |
| STPH O | insert question ? and 2 spaces |
| STPN*BEG. | insert question ? and no spaces |
| SWR *BEG. | insert comma, |
| SWR A | insert open paren( |
| SWR A and O | insert close paren) |
| STPH A | insert inverted question [symbol] |
| STKP A | insert open quotes“ |
| STKP A and O | insert close quotes” |
| STKH A | insert open single quotes‘ |
| STKH A and O | insert close single quotes’ |
| TWR A | insert apostrophe and s's |
| STWR A | insert apostrophe 's |
| SKWR AO | insert ellipsis . . . |
| AO + Tog B | cap last word |
| O*BEG + Tog B | all cap last word |
| STWR O | s apostrophe s' |
| KWHR A | hyphen - |
| KWHR O | dash - |
| BEG.* + Tog B | Delete last stroke |

In forming particular accents and/or symbols used to communicate in the English language, Table VII shows exemplar accents and symbols and usable key indicators. The user may set and modify either such accents and symbols, as well as the key indicators associated to create particular accents and symbols. In general, the “A” key places the accent over the last text letter formed by the user, while the “O” key inserts the particular accent after the last letter formed.

TABLE VII
SYMBOLS & ACCENTS

| | |
|---|---|
| SYMBOLS and ACCENTS | POSSIBLE KEY INDICATORS |

| | | | |
|---|---|---|---|
| _{—} | over line | | |
| _{—} | under line | | |
| + | | STPW | A |
| ∩ | over | STPW | O |
| ∪ | over | STWH | A |
| / | back slash | STWH | O |
| \ | forward slash | SPWHR | A |
| = | | SPWHR | O |
| ≠ | | KPWR | A |
| > | | KPWR | O |
| < | | KWH | A |
| > | | KWH | O |
| < | | | |
| [symbol] | over | | |
| / | over | STKWH | A |
| \ | over | STKWH | O |
| ″ | over | PWH | A |
| [symbol] | under | SKPWH | O |
| [symbol] | over | STKPW | A |
| . | over | STKPW | O |
| ∘ | over | SKPNR | A |
| # | | SKPHR | O |
| | | KPWHR | A |
| | | KPWHR | O |
| | | TWHR | A |
| | | TWHR | O |
| | | STKWHR | A |
| | | STKWHR | O |
| | | STKPWR | A |
| | | STKPWR | O |
| | | SKPW | A |
| | | SKPW | O |
| | | STPWR | A |
| | | STPWR | O |

The following VIII Table identifies the employment of particular actuators of plurality of actuators 46 resulting in the production of consonant combinations to form words:

TABLE VIII
CONSONANT COMBINATIONS

| | CONSONANT |
|---|---|
| KEYS USED | COMBINATIONS |
| PWR | BR |
| TKPWR | GR |
| STR | STR |
| WH | WH |
| PWHR | BL |
| PHR | PL |
| TKHR | LL |
| SKH | SCH |
| SHR | SL |
| SW | SW |
| SH | SH |
| TKR | DR |
| KR | CR |
| STH | PH |
| TPHR | FL |
| TR | TR |
| TPR | FR |
| KH | CH |
| KHR | CL |
| PR | PR |
| ST | ST |
| SP | SP |
| SK | SC |
| SPR | SPR |
| SKR | SCR |
| SPH | SM |

The following Table IX shows actuator 46 combinations used for forming Arabic numbers.

TABLE IX
ARABIC NUMBERS

| KEY USED | NUMBERS |
|---|---|
| RA + Tog A | 0 |
| SA + Tog B | 1 |
| TA + Tog B | 2 |
| PA + Tog A | 3 |
| HA + Tog A | 4 |
| WA + Tog A | 5 |
| SO + Tog B | 6 |
| TO + Tog B | 7 |
| PO + Tog A | 8 |
| HO + Tog A | 9 |

The following Table X illustrates user-specific phrases that may be implemented using pad actuator 24 (#) with other actuators. The use of actuator 10B is only limited by the user's ability to recall, the desired implementation keys for the phrases needed.

TABLE X
SAMPLE

Meet you at
Pick you up at
See you at
Call me
Call when you get this
Call me tonight
Are you available for lunch?
Don't forget

After becoming familiar with the plurality of actuators on actuator structure 10B, the user may easily produce words in one stroke, using one hand. For example, the following words are created with denoted character keys, or actuators.

| WORD | KEYS USED |
|---|---|
| Sherrie | Fk, S H, Tog. B, Beg*, # key, A, RY |
| Shari | S, H, Beg*, A, RY |
| Cheri | K, H, Tog. B, Beg*, Ry |
| Sherry | FK, S, H, Tog B, A, Ry |
| Sharie | S, H, # Key, Beg*, RY |
| Cherry | FK, K, H, Tog B, A Ry |
| Sherri | FK, S, H, Tog B, Beg*A, Ry |

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A character actuator device for forming a polysyllabic word employing two hands of a user,
comprising:
a. a first plurality of actuators, each actuator of said first plurality of actuators representing a character of a first plurality of characters useable to form a beginning of the polysyllabic word;
b. a second plurality of actuators, each actuator of said second plurality of actuators representing a character of a second plurality of characters, and a third plurality of actuators, each actuator of said third plurality of actuators representing a character of a third plurality of characters, said second and third characters representing an ending of the polysyllabic word; said beginning and ending of the polysyllabic word being independent of the syllabic content of the polysyllabic word; and
c. a fourth category of actuators, each actuator of said fourth category of actuators representing a particular character representing an alteration of the polysyllabic word being formed by said first, second, and third character actuators, any one of each of said first, second, third and fourth plurality of actuators being adapted for simultaneous activation.

2. The device of claim 1 in which one actuator said fourth categorized actuators provides for capitalizing of one or more words formed by said first, second, and third categories of actuators.

3. The device of claim 1 in which one actuator of said fourth category of actuators provides for accenting a word being formed by said first, second, and third categories of actuators.

4. The device of claim 1 in which one actuator said fourth, category of actuator provides for adding a “y” ending to a word being formed by said first, second, and third categories of actuators.

5. The device of claim 1 in which one actuator of said fourth category of actuators provides for adding an “ry” ending to a word being formed by said, first, second, and third categories of actuators.

6. The device of claim 1 in which one actuator of said fourth category of actuators provides for changing one vowel character to a word being formed by said first, second and third plurality of characters, to another vowel character.

7. The device of claim 1 in which one actuator of said fourth category of actuators provides for adding a consonant to a word being formed by said first, second, and third categories of actuators.

8. The device of claim 1 in which one actuator of said fourth category of actuator of said fourth category of actuators provides for adding a vowel to a word being formed by said first, second, and third categories of actuators.

9. The device of claim 1 in which one actuator of said fourth category of actuators provides for shifting the representation of said characters by said first, second, and third plurality of actuators between characters in the Roman and non-Roman alphabet.

10. A character actuator device used for texting language employing a single hand of a user comprising:
a. a first plurality of finger activated character actuators and
b. at least one palm activated character actuators, at least one of said plurality of finger activated character actuators being adapted for simultaneous activation with said palm activated character actuator to produce an output representing a word, a series of words, or a portion of a word.

11. The device of claim 10 in which said device output comprising a series of word comprises a phrase.

12. A method of texting a phrase employing single hand:
a. activating a first character actuator on a keyboard by use of a finger of a single hand of the user,
b. simultaneously actuating a second character actuator using the palm region of the single hand of the user to produce a signal representing a phrase.
